(19) United States
(12) Patent Application Publication
(10) Pub. No.: US 2026/0183962 A1
(43) Pub. Date: Jul. 2, 2026

(54) METHOD, APPARATUS AND DEVICE FOR CALIBRATING EXTERNAL ACTUATOR OF ROBOT

(71) Applicant: GUANGDONG UNIVERSITY OF TECHNOLOGY, Guangzhou (CN)

(72) Inventors: Jian GAO, Guangzhou (CN); Xin LIU, Guangzhou (CN); Zhuojun ZHENG, Guangzhou (CN); Lanyu ZHANG, Guangzhou (CN); Xin CHEN, Guangzhou (CN)

(21) Appl. No.: 19/437,545

(22) Filed: Dec. 31, 2025

Related U.S. Application Data
(63) Continuation of application No. PCT/CN2025/123999, filed on Sep. 25, 2025.

(30) Foreign Application Priority Data
Dec. 31, 2024 (CN) 202411976568.7

(51) Int. Cl. B25J 9/16

(52) U.S. Cl. CPC B25J 9/1692

(57) ABSTRACT

A method for calibrating an external actuator of a robot includes: enabling an end of a robotic arm with a calibration plate to be in contact with the actuator in different poses, and obtaining two different circular mark points and preset transformation matrices; calculating three-dimensional point cloud coordinates of the circular mark points based on a mapping relationship between pixel coordinates and point cloud coordinates in a structured light system; calculating a pose transformation matrix between two poses of the end of the robotic arm; calculating actuator coordinates of an end of the actuator in a base coordinate system of the robotic arm; calculating a direction vector of the end of the actuator through two different sets of actuator coordinates; and calculating a homogeneous transformation matrix for calibrating and aligning the end of the actuator according to the direction vector to obtain a calibration result.

### CROSS-REFERENCE TO RELATED APPLICATIONS

This application is a continuation of International Patent Application No. PCT/CN2025/123999 with a filing date of Sep. 25, 2025, designating the United States, now pending, and further claims priority to Chinese Patent Application No. 202411976568.7 with a filing date of Dec. 31, 2024. The content of the aforementioned applications, including any intervening amendments thereto, are incorporated herein by reference.

### TECHNICAL FIELD

The present application relates to the technical field of robot control, and particularly to a method, an apparatus and a device for calibrating an external actuator of a robot.

### BACKGROUND OF THE PRESENT INVENTION

In the fields of electronic manufacturing and aviation industry, robots are often used for assembly of electronic products and screw assembly of aircraft wing skin. An operating actuator of a robot is often located at an end of a robotic arm, and compared with this kind of actuator, an actuator located outside the robot is more suitable for a flexible assembly system. The latter may adapt to hole sites with different sizes and poses during assembly; and has the advantages of flexible operation, independent of teaching operation, various applicable workpieces, and the like. However, when this kind of actuator located outside the robot is used for assembly, it is very difficult to determine a pose transformation relationship of the external actuator relative to a base coordinate system of the robotic arm.

Existing methods mainly include a visual tracking method, a laser interferometer measurement method, and the like, wherein the visual tracking method has low measurement accuracy; while the laser interferometer has high measurement accuracy, but it is difficult to meet calibration requirements in many different scenes because of a single measurement freedom, a complex operation process, a high device cost and sensitivity to environmental disturbance.

### SUMMARY OF THE PRESENT INVENTION

The present application provides a method, an apparatus and a device for calibrating an external actuator of a robot for solving the technical problem that the requirement of actual calibration scene is difficult to meet due to the problems of low accuracy, complex measurement process, high cost and the like in the prior art.

In view of this, in a first aspect, the present application provides a method for calibrating an external actuator of a robot, which includes the following steps:
enabling an end of a robotic arm with a calibration plate to be in contact with the actuator in different poses, and obtaining two different circular mark points and corresponding preset transformation matrices from a base to the end of the robotic arm;
respectively calculating three-dimensional point cloud coordinates of the two circular mark points based on a mapping relationship between pixel coordinates and point cloud coordinates in a structured light system;
calculating a transformation matrix between two poses of the end of the robotic arm according to the preset transformation matrices to obtain a pose transformation matrix;
calculating a position of an end of the actuator in a base coordinate system of the robotic arm according to the three-dimensional point cloud coordinates, the pose transformation matrix and a preset hand-eye matrix to obtain actuator coordinates;
calculating a direction vector of the end of the actuator in the base coordinate system of the robotic arm through two different sets of actuator coordinates; and
calculating a homogeneous transformation matrix for calibrating and aligning the end of the actuator according to the direction vector to obtain a calibration result.

Preferably, before the step of enabling the end of the robotic arm with the calibration plate to be in contact with the actuator in different poses, and obtaining the two different circular mark points and the corresponding preset transformation matrices from the base to the end of the robotic arm, the method further includes the following steps:
fixing the calibration plate on the end of the robotic arm, adjusting a pose of the end of the robotic arm repeatedly, and simultaneously shooting a plurality of images and recording poses of the end of the robotic arm to obtain the pose of the end of the robotic arm;
determining the mapping relationship between the pixel coordinates and the point cloud coordinates according to intrinsic matrices of a camera and a projector of the structured light system; and
calibrating a matrix from a camera coordinate system to the base coordinate system of the robotic arm according to the pose of the end of the robotic arm and the intrinsic matrices to obtain the preset hand-eye matrix.

Preferably, the step of respectively calculating the three-dimensional point cloud coordinates of the two circular mark points based on the mapping relationship between the pixel coordinates and the point cloud coordinates in the structured light system, includes:
moving the two circular mark points of the calibration plate to a visual field of the structured light system, and shooting a mark point image;
performing a center mark fitting operation according to the mark point image to obtain center pixel coordinates; and
calculating point cloud coordinates corresponding to the center pixel coordinates based on the mapping relationship between the pixel coordinates and the point cloud coordinates to obtain the three-dimensional point cloud coordinates of the circular marker points.

Preferably, the step of calculating the position of the end of the actuator in the base coordinate system of the robotic arm according to the three-dimensional point cloud coordinates, the pose transformation matrix and the preset hand-eye matrix to obtain the actuator coordinates, includes:
calculating homogeneous coordinates of point cloud according to the three-dimensional point cloud coordinates; and
calculating the position of the end of the actuator in the base coordinate system of the robotic arm according to the homogeneous coordinates of point cloud, the pose transformation matrix and the preset hand-eye matrix to obtain the actuator coordinates.

Preferably, the step of calculating the homogeneous transformation matrix for calibrating and aligning the end of the actuator according to the direction vector to obtain the calibration result, includes:
calculating a vector cross product according to a normalized direction vector and a normal vector of an arbitrary point in the base coordinate system of the robotic arm to obtain a rotation axis vector;
constructing a rotation matrix according to the rotation axis vector and an included angle between vectors, wherein the included angle between vectors is an included angle between the direction vector and the normal vector of the arbitrary point; and
calculating the homogeneous transformation matrix for calibrating and aligning the end of the actuator according to the rotation matrix and a preset translation vector to obtain the calibration result.

Preferably, before the step of calculating the homogeneous transformation matrix for calibrating and aligning the end of the actuator according to the rotation matrix and the preset translation vector to obtain the calibration result, the method further includes the following steps:
taking the actuator coordinates calculated for the first time as homogeneous coordinates of pose of a current circular mark point when the end of the robotic arm is in a first pose state; and
constructing the preset translation vector according to the homogeneous coordinates of pose and coordinates of the arbitrary point.

In a second aspect, the present application provides an apparatus for calibrating an external actuator of a robot, which includes:
a pose marking unit configured for enabling an end of a robotic arm with a calibration plate to be in contact with the actuator in different poses, and obtaining two different circular mark points and corresponding preset transformation matrices from a base to the end of the robotic arm;
a coordinate calculating unit configured for respectively calculating three-dimensional point cloud coordinates of the two circular mark points based on a mapping relationship between pixel coordinates and point cloud coordinates in a structured light system;
a matrix transforming unit configured for calculating transformation matrix between two poses of the end of the robotic arm according to the preset transformation matrices to obtain a pose transformation matrix;
an end positioning unit configured for calculating a position of an end of the actuator in a base coordinate system of the robotic arm according to the three-dimensional point cloud coordinates, the pose transformation matrix and a preset hand-eye matrix to obtain actuator coordinates;
a vector calculating unit configured for calculating a direction vector of the end of the actuator in the base coordinate system of the robotic arm through two different sets of actuator coordinates; and
a homogeneous calibration unit configured for calculating a homogeneous transformation matrix for calibrating and aligning the end of the actuator according to the direction vector to obtain a calibration result.

Preferably, the coordinate calculating unit is specifically configured for:
moving the two circular mark points of the calibration plate to a visual field of the structured light system, and shooting a mark point image;
performing a center mark fitting operation according to the mark point image to obtain center pixel coordinates; and
calculating point cloud coordinates corresponding to the center pixel coordinates based on the mapping relationship between the pixel coordinates and the point cloud coordinates to obtain the three-dimensional point cloud coordinates of the circular marker points.

Preferably, the homogeneous calibration unit is specifically configured for:
calculating a vector cross product according to a normalized direction vector and a normal vector of an arbitrary point in the base coordinate system of the robotic arm to obtain a rotation axis vector;
constructing a rotation matrix according to the rotation axis vector and an included angle between vectors, wherein the included angle between vectors is an included angle between the direction vector and the normal vector of the arbitrary point; and
calculating the homogeneous transformation matrix for calibrating and aligning the end of the actuator according to the rotation matrix and a preset translation vector to obtain the calibration result.

In a third aspect, the present application provides a device for calibrating an external actuator of a robot, wherein the device includes a processor and a storage;
the storage is used for storing a program code and transmitting the program code to the processor; and
the processor is used for executing the method for calibrating the external actuator of the robot in the first aspect according to an instruction in the program code.

It can be seen from the technical solution above that the embodiments of present application have the following advantages.

The present application provides the method for calibrating the external actuator of the robot, which includes the following steps: enabling the end of the robotic arm with the calibration plate to be in contact with the actuator in different poses, and obtaining the two different circular mark points and the corresponding preset transformation matrices from the base to the end of the robotic arm; respectively calculating the three-dimensional point cloud coordinates of the two circular mark points based on the mapping relationship between the pixel coordinates and the point cloud coordinates in the structured light system; calculating the transformation matrix between the two poses of the end of the robotic arm according to the preset transformation matrices to obtain the pose transformation matrix; calculating the position of the end of the actuator in the base coordinate system of the robotic arm according to the three-dimensional point cloud coordinates, the pose transformation matrix and the preset hand-eye matrix to obtain the actuator coordinates; calculating the direction vector of the end of the actuator in the base coordinate system of the robotic arm through the two different sets of actuator coordinates; and calculating the homogeneous transformation matrix for calibrating and aligning the end of the actuator according to the direction vector to obtain the calibration result.

According to the method for calibrating the external actuator of the robot provided by the present application, the calibration plate is arranged at the end of the robotic arm, and pose information of the end of the actuator is solved based on the mark points obtained by two contact operations, so that an influence caused by a repeated positioning error of the robotic arm may be eliminated; moreover, the structured light system is introduced to solve the three-dimensional point cloud coordinates of the marker points, which achieves higher accuracy in a Z-axis direction; then, the homogeneous transformation matrix of the calibration result is determined by specific matrix and vector, and other calculation methods, which is independent of a complex operation process, and can also ensure an accurate calculation result; and there is only an actual operation action of taking mark points for different poses of the calibration plate, which can meet the calibration requirement of multiple poses, without involving a high cost. Therefore, the present application can solve the technical problem that the requirement of actual calibration scene is difficult to meet due to the problems of low accuracy, complex measurement process, high cost and the like in the prior art.

### DESCRIPTION OF THE DRAWINGS

FIG. 1 is a flow chart of a method for calibrating an external actuator of a robot provided by an embodiment of the present application;

FIG. 2 is a schematic structural diagram of an apparatus for calibrating an external actuator of a robot provided by an embodiment of the present application;

FIG. 3 is a schematic diagram of an overall structure of the apparatus for calibrating the external actuator of the robot provided by the embodiment of the present application;

FIG. 4 is a schematic diagram of a relationship between a circular mark point left by an actuator on a calibration plate and an angular points of the calibration plate provided by the embodiment of the present application; and

FIG. 5 is a schematic diagram of the circular mark point on the calibration plate provided by the embodiment of the present application.

### DETAILED DESCRIPTION OF PREFERRED EMBODIMENTS

In order to make those skilled in the art better understand the solution of the present application, technical solutions in embodiments of the present application are clearly and completely described hereinafter with reference to the drawings in the embodiments of the present application. Apparently, the described embodiments are merely some but not all of the embodiments of the present application. Based on the embodiments of the present application, all other embodiments obtained by those of ordinary skills in the art without going through any creative work shall fall within the scope of protection of the present application.

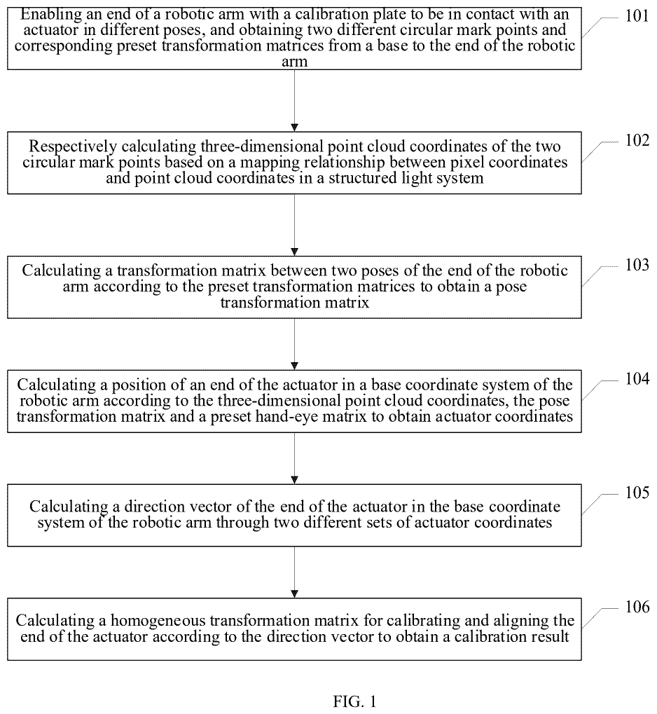

For easy understanding, with reference to FIG. 1, the present application provides a method for calibrating an external actuator of a robot, which includes the following steps.

In step 101, an end of a robotic arm with a calibration plate is in contact with the actuator in different poses, and two different circular mark points and corresponding preset transformation matrices from a base to the end of the robotic arm are obtained.

Further, before the step 101, the method further includes the following steps:
fixing the calibration plate on the end of the robotic arm, adjusting a pose of the end of the robotic arm repeatedly, and simultaneously shooting a plurality of images and recording poses of the end of the robotic arm to obtain the pose of the end of the robotic arm;
determining a mapping relationship between pixel coordinates and point cloud coordinates according to intrinsic matrices of a camera and a projector of a structured light system; and
calibrating a matrix from a camera coordinate system to a base coordinate system of the robotic arm according to the pose of the end of the robotic arm and the intrinsic matrices to obtain a preset hand-eye matrix.

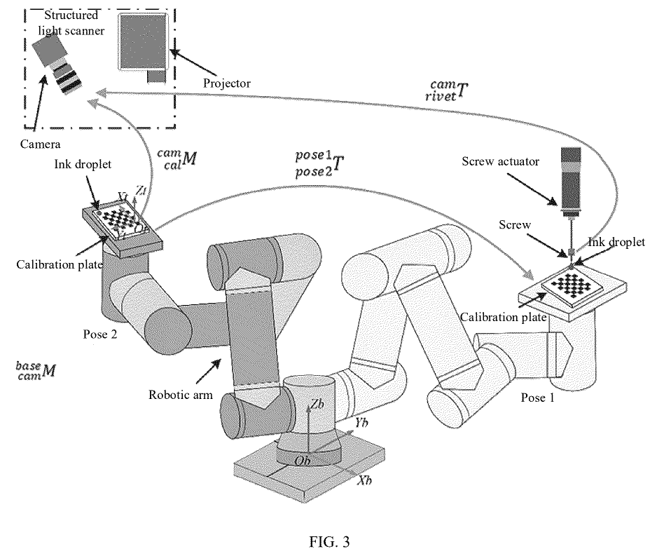

It should be noted that, with reference to FIG. 3, devices in this embodiment include the calibration plate, a structured light scanner, the robotic arm and the external actuator. After arranging the calibration plate on the end of the robotic arm, a pose of the end of the robotic arm may be adjusted repeatedly to take photos in different poses, and images are acquired and poses of the end of the robotic arm at corresponding moments are recorded to obtain the pose of the end of the robotic arm, which is recorded as

$${base}_{end}^{} M .$$

After the camera and the projector inside the structured light scanner in the structured light system are calibrated by the calibration plate arranged on the end of the robotic arm, the intrinsic matrices of the camera and the projector are acquired, and the intrinsic matrices of the camera and the projector may be expressed as K_{cam} and Kₚᵣₒ, which are specifically expressed as follows:

$${K}_{cam} = ( \begin{matrix}{f}_{xc} & {λ}_{c} & {c}_{xc} \\ 0 & {f}_{yc} & {c}_{yc} \\ 0 & 0 & 1\end{matrix} )$$

$${K}_{pro} = ( \begin{matrix}{f}_{xp} & {λ}_{p} & {c}_{xp} \\ 0 & {f}_{yp} & {c}_{yp} \\ 0 & 0 & 1\end{matrix} )$$

wherein, f_{xc}, f_{yc}, fₓₚ and f_{yp} are respectively focal lengths of the camera and the projector on an x axis and a y axis, and numerical values of the focal lengths are ratios of actual focal lengths of the camera and the projector to pixel sizes on sensors of the camera and the projector. c_{xc}, c_{yc}, cₓₚ and c_{yp} are respectively coordinates of intersections between optical axes of the camera and the projector and image planes of the camera and the projector on the x axis and the y axis, and λ_{c} and λₚ respectively represent non-orthogonalities between coordinate axes of the camera and the projector. In an idea case, values of the λ_{c} and the λₚ are 0, and when the image planes of the camera and the projector are non-orthogonal, the values are not 0.

The preset hand-eye matrix from the camera coordinate system to the base coordinate system of the robotic arm may be calibrated according to the pose of the end of the robotic arm and the intrinsic matrices. Specifically, a transformation relationship

$${cam}_{point}^{} {M}_{i}$$

of the camera coordinate system relative to an origin coordinate system of the mark point of the calibration plate may be acquired according to the plurality of images of the calibration plate acquired above; and an equation set may be constructed according to a transformation relationship

$${point}_{end}^{} M$$

of origin coordinates of the calibration plate relative to the end of the robotic arm and a transformation relationship

$${base}_{end}^{} {M}_{i}$$

of a base of the robotic arm relative to the end of the robotic arm:

$${cam}_{paint}^{} {M}_{i} {point}_{end}^{} M = {cam}_{base}^{} M {base}_{end}^{} {M}_{i}$$

wherein,

$${cam}_{base}^{} M$$

is the preset hand-eye matrix, and the equation is AX=ZB, wherein i is a number of photos of the calibration plate when calibrating intrinsics, which is generally 25 to 40;

$${point}_{end}^{} M$$

$$and$$

$${cam}_{base}^{} M$$

are invariant in the equation; and the preset hand-eye matrix

$${cam}_{base}^{} M$$

may be obtained by solving via a Kronecker product method:

$${cam}_{base}^{} M = ( \begin{matrix}{cam}_{base}^{} {R}_{3 \times 3} & {cam}_{base}^{} {t}_{3 \times 1} \\ 0 & 1\end{matrix} )$$

wherein,

$${cam}_{base}^{} {R}_{3 \times 3}$$

$$and$$

$${cam}_{base}^{} {t}_{3 \times 1}$$

respectively represent a rotation transformation relationship and a translation transformation relationship from the camera coordinate system to the base coordinate system of the robotic arm, wherein the base coordinate system of the robotic arm is a world coordinate system; and the preset hand-eye matrix

$${cam}_{base}^{} M$$

has a size of 4×4, and represents a rigid transformation with 6 degrees of freedom.

The preset transformation matrix from the base to the end of the robotic arm is expressed as follows:

$${base}_{pose}^{} M = ( \begin{matrix}{base}_{pose}^{} {R}_{3 \times 3} & {base}_{pose}^{} {t}_{3 \times 1} \\ 0 & 1\end{matrix} )$$

wherein,

$${base}_{pose}^{} {R}_{3 \times 3}$$

$$and$$

$${base}_{pose}^{} {t}_{3 \times 1}$$

respectively represent transformation relationships from the base coordinate system of the robotic arm to an end coordinate system of the robotic arm. In this embodiment, the end of the robotic arm needs to be operated to act twice, which may be recorded as a pose 1 and a pose 2. When the end of the robotic arm with the calibration plate is moved to reach the pose 1, an end of the actuator with a colored ink droplet will be in contact with the calibration plate, so as to leave the circular mark point on the calibration plate, and meanwhile, a transformation matrix from the base to the end of the robotic arm in the pose 1 also needs to be recorded, which is the preset transformation matrix

$${base}_{pose 1}^{} M .$$

Similarly, the end of the robotic arm may be operated to act again to reach the pose 2, and the other circular marker point and the corresponding preset transformation matrix

$${}_{base}^{pose 2} M$$

may also be determined. It should be noted that, in this embodiment, the pose 2 is within a visual field of an optical scanner in the structured light system.

In step 102, three-dimensional point cloud coordinates of the two circular mark points are respectively calculated based on the mapping relationship between the pixel coordinates and the point cloud coordinates in the structured light system.

Further, the step 102 includes:
moving the two circular mark points of the calibration plate to a visual field of the structured light system, and shooting a mark point image;
performing a center mark fitting operation according to the mark point image to obtain center pixel coordinates; and
calculating point cloud coordinates corresponding to the center pixel coordinates based on the mapping relationship between the pixel coordinates and the point cloud coordinates to obtain the three-dimensional point cloud coordinates of the circular marker points.

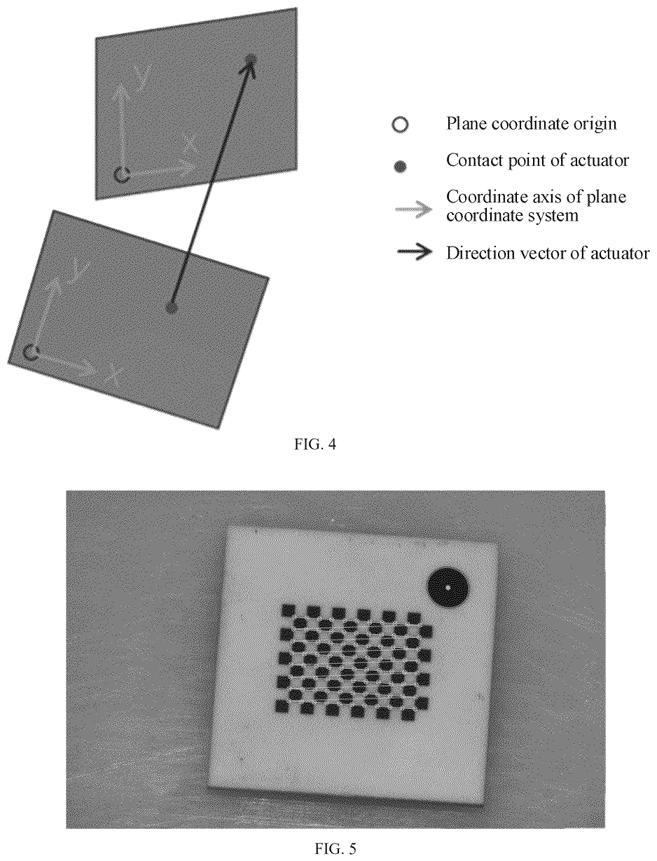

The end of the robotic arm may be moved to reach different poses as above, and the two different circular mark points and the corresponding preset transformation matrices are determined. With reference to FIG. 4 and FIG. 5, the two circular mark points of the calibration plate may be moved to the visual field of the structured light system, and the mark point image is shot. Center fitting may be performed on the mark point image according to geometric characteristics of the image to obtain the center pixel coordinates, which are recorded as Îₚᵢₓₑₗ, and expressed as Îₚᵢₓₑₗ=(Îₓ, Î_{y})^{T}, and by taking an origin of the calibration plate as a reference coordinate system, a size is 2×1.

The mapping relationship between the pixel coordinates and the point cloud coordinates may be expressed as follows:

$$f : {ℝ}^{2} \to {ℝ}^{3}$$

which refers to a mapping from a two-dimensional point set to a three-dimensional point set, wherein:

$$f ( {I}_{x} , {I}_{y} ) = C ( {I}_{x} , {I}_{y} ) = {( {C}_{x} , {C}_{y} , {C}_{z} )}^{T}$$

This process refers to finding corresponding point cloud coordinates (Cₓ, C_{y}, C_{z})^{T} in the three-dimensional point set {C_{i,j}} by using the center pixel coordinates Îₚᵢₓₑₗ=(Îₓ, Î_{y})^{T}, which are the three-dimensional point cloud coordinates C, and established in the camera coordinate system of the structured light system.

In step 103, a transformation matrix between two poses of the end of the robotic arm is calculated according to the preset transformation matrices to obtain a pose transformation matrix.

In this embodiment, preset transformation matrices corresponding to the two circular marker points are respectively expressed as

$${}_{base}^{pose 1} M and {}_{base}^{pose 2} M ,$$

the pose 1 to the pose 2 may be calculated according to the two preset transformation matrices to obtain the pose transformation matrix

$${}_{pose 1}^{pose 2} M ,$$

which may be specifically expressed as follows:

$${}_{{pose}_{1}}^{{pose}_{2}} M = {}_{base}^{{pose}_{2}} M {}_{base}^{{pose}_{1}} {M}^{- 1}$$

In step 104, a position of the end of the actuator in the base coordinate system of the robotic arm is calculated according to the three-dimensional point cloud coordinates, the pose transformation matrix and the preset hand-eye matrix to obtain actuator coordinates.

Further, the step 104 includes:
calculating homogeneous coordinates of point cloud according to the three-dimensional point cloud coordinates; and
calculating the position of the end of the actuator in the base coordinate system of the robotic arm according to the homogeneous coordinates of point cloud, the pose transformation matrix and the preset hand-eye matrix to obtain the actuator coordinates.

The homogeneous coordinates I_{cam1} of point cloud may be calculated according to the three-dimensional point cloud coordinates C=(Cₓ, C_{y}, C_{z})^{T} calculated above, and a specific process is expressed as follows:

$${I}_{{cam}_{1}} = {( {I}_{cx} , {I}_{cy} , {I}_{cz} , 1 )}^{T}$$

$$wherein {I}_{cx} = {C}_{x} , {I}_{cy} = {C}_{y} and {I}_{cz} = {C}_{z} .$$

A process of calculating the actuator coordinates I_{world1} according to the homogeneous coordinates I_{cam1} of point cloud, the pose transformation matrix

$${}_{pose 1}^{pose 2} M$$

and the preset hand-eye matrix

$${}_{cam}^{base} M$$

is expressed as follows:

$${I}_{tool} = {I}_{{world}_{1}} = {}_{{pose}_{1}}^{{pose}_{2}} {M}^{- 1} {}_{cam}^{base} M {I}_{{cam}_{1}} = {( {I}_{x 1} , {I}_{y 1} , {I}_{z 1} , 1 )}^{T}$$

wherein, I_{world1} is a first pose state, which refers to the actuator coordinates calculated in a state of the pose 1, so as to be recorded as homogeneous coordinates Iₜₒₒₗ of pose.

By repeating the above operation on the pose state of the end of the robotic arm, position coordinates of another set of different circular marker points in the base coordinate system of the robotic arm may be calculated, which are another set of actuator coordinates I_{world2}. Specifically, it is only necessary to operate the end of the robotic arm to be in contact with the end of the actuator again, shoot circular mark points, and record mark points and preset transformation matrices

$${}_{base}^{pose 3} M and {}_{base}^{pose 4} M$$

in a pose 3 and a pose 4, and then, specific actuator coordinates I_{world2} may be calculated according to the above method. However, in this embodiment, it is required to avoid a singularity occurring in the equation caused by the case that the mark points of the two contacts are located in the same position, so that the transformation matrices

$${}_{base}^{pose 3} M and {}_{base}^{pose 4} M$$

need to meet the following conditions:

$${}_{base}^{{pose}_{3}} M \neq {}_{base}^{{pose}_{1}} M$$

$${}_{base}^{{pose}_{4}} M \neq {}_{base}^{{pose}_{2}} M$$

An identity matrix of a dot product element of the pose transformation matrix from the pose 1 to the pose 2 and a pose transformation matrix from the pose 4 to the pose 3 is as follows:

$${}_{{pose}_{1}}^{{pose}_{2}} M {}_{{pose}_{4}}^{{pose}_{3}} M \neq {E}_{4 \times 4} = ( \begin{matrix}1 & 0 & 0 & 0 \\ 0 & 1 & 0 & 0 \\ 0 & 0 & 1 & 0 \\ 0 & 0 & 0 & 1\end{matrix} )$$

wherein:

$${}_{{pose}_{4}}^{{pose}_{3}} M = {( {}_{base}^{{pose}_{4}} M {}_{base}^{{pose}_{3}} {M}^{- 1} )}^{- 1} = {}_{base}^{{pose}_{3}} M {}_{base}^{{pose}_{4}} {M}^{- 1}$$

wherein,

$${}_{pose 4}^{pose 3} M$$

is the pose transformation matrix from the pose 4 to the pose 3 of the end of the robotic arm, with a size of 4×4, and the actuator coordinates I_{world2} in the base coordinate system of the robotic arm may be expressed as follows:

$${I}_{{world}_{2}} = {}_{{pose}_{1}}^{{pose}_{3}} M {}_{{pose}_{4}}^{{pose}_{3}} M {}_{cam}^{base} M {I}_{{cam}_{2}} = {( {I}_{x 2} , {I}_{y 2} , {I}_{z 2} , 1 )}^{T}$$

wherein:

$${}_{{pose}_{1}}^{{pose}_{3}} M = {}_{base}^{{pose}_{3}} M {}_{{pose}_{1}}^{base} M = {}_{base}^{{pose}_{3}} M {}_{base}^{{pose}_{1}} {M}^{- 1}$$

wherein,

$${}_{pose 1}^{pose 3} M$$

represents a pose transformation matrix from the pose 1 to the pose 3 of the end of the robotic arm, with a size 4×4,

$${}_{pose 1}^{base} M$$

is a transformation matrix from the end to the base of the robotic arm in the state of the pose 1, and the transformation matrix from the end to the base of the robotic arm in the state of the pose 1 and the transformation matrix

$${}_{base}^{pose 1} M$$

from the base to the end of the robotic arm in the state of the pose 1 are inverse matrices of each other.

In step 105, a direction vector of the end of the actuator in the base coordinate system of the robotic arm is calculated through two different sets of actuator coordinates.

The direction vector m of the end of the actuator in the base coordinate system of the robotic arm may be calculated according to the two different sets of actuator coordinates I_{world1} and I_{world2} above. A specific process of determining the direction vector m is expressed as follows:

$$m = ( {I}_{x 1} - {I}_{x 2} , {I}_{y 1} - {I}_{y 2} , {I}_{z 1} - {I}_{z 2} )$$

In step 106, a homogeneous transformation matrix for calibrating and aligning the end of the actuator is calculated according to the direction vector to obtain a calibration result.

Further, the step 106 includes:
calculating a vector cross product according to a normalized direction vector and a normal vector of an arbitrary point in the base coordinate system of the robotic arm to obtain a rotation axis vector;
constructing a rotation matrix according to the rotation axis vector and an included angle between vectors, wherein the included angle between vectors is an included angle between the direction vector and the normal vector of the arbitrary point; and
calculating the homogeneous transformation matrix for calibrating and aligning the end of the actuator according to the rotation matrix and a preset translation vector to obtain the calibration result.

Further, before the step of calculating the homogeneous transformation matrix for calibrating and aligning the end of the actuator according to the rotation matrix and the preset translation vector to obtain the calibration result, the method further includes the following steps:
taking the actuator coordinates calculated for the first time as homogeneous coordinates of pose of a current circular mark point when the end of the robotic arm is in a first pose state; and
constructing the preset translation vector according to the homogeneous coordinates of pose and coordinates of the arbitrary point.

It should be noted that, after the direction vector m is calculated above, the direction vector m is normalized to obtain m, and a specific process is as follows:

$$\hat{m} = \frac{m}{\vert m \vert} = ( \frac{{m}_{x}}{\vert m \vert} , \frac{{m}_{y}}{\vert m \vert} , \frac{{m}_{z}}{\vert m \vert} )$$

wherein, mₓ, m_{y} and m_{z} respectively represent components of the vector m in three coordinate axes x, y and z in a three-dimensional rectangular coordinate system, wherein a modulus length of an unnormalized direction vector m is as follows:

$$\vert m \vert = \sqrt{{m}_{x}^{2} + {m}_{y}^{2} + {m}_{z}^{2}}$$

An arbitrary point in the base coordinate system of the robotic arm may be recorded as P=(Pₓ, P_{y}, P_{z}), and a normal vector of the arbitrary point may be recorded as mₚ=(mₚₓ, m_{py}, m_{pz}). Before calibration calculation, it is necessary to construct the preset translation vector ty according to the homogeneous coordinates Iₜₒₒₗ of pose defined and obtained above and coordinates P=(Pₓ, P_{y}, P_{z}) of the arbitrary point:

$${t}_{p} = {( {I}_{x 1} - {P}_{x} , {I}_{y 1} - {P}_{y} , {I}_{z 1} - {P}_{z} )}^{T}$$

A rotation axis-rotation angle model may be constructed according to the normalized direction vector \hat{m} and the normal vector mₚ=(mₚₓ, m_{py}, m_{pz}) of the arbitrary point, a rotation axis is a cross product of two vectors, and the rotation axis is recorded as a vector a of the vector cross product:

$$a = {m}_{p} \times \hat{m} = ( {a}_{x} , {a}_{y} , {a}_{z} )$$

wherein, aₓ, a_{y} and a_{z} respectively represent components of the rotation axis a on three coordinate axes x, y and z in the three-dimensional rectangular coordinate system.

A rotation angle θ is an included angle between two vectors:

$$θ = arccos ( \frac{{m}_{p} \cdot \hat{m}}{\vert {m}_{p} \vert \vert \hat{m} \vert} )$$

Then, a rotation matrix may be expressed as follows:

$${R}_{p} = {E}_{3 \times 3} + sin ( θ ) A + ( 1 - cos ( θ ) ) {A}^{2}$$

wherein, E_{3×3} is an identity matrix, and A is a skew-symmetric matrix of the rotation axis a, and expressed as follows:

$$A = ( \begin{matrix}0 & - {a}_{z} & {a}_{y} \\ {a}_{z} & 0 & - {a}_{x} \\ - {a}_{y} & {a}_{x} & 0\end{matrix} )$$

The homogeneous transformation matrix Tₚ for calibrating and aligning the end of the actuator may be calculated according to the rotation matrix Rₚ and the preset translation vector tₚ.

$${T}_{p} = ( \begin{matrix}{R}_{p} & {t}_{p} \\ 0 & 1\end{matrix} )$$

The arbitrary point P in the base coordinate system of the robotic arm may be aligned to the end of the external actuator of the robotic arm according to the obtained homogeneous transformation matrix Tₚ. Based on this principle, the end of the robotic arm with any workpiece to be machined or assembled may be operated to move to the end of the actuator, so as to complete a machining or assembly task.

According to the method for calibrating the external actuator of the robot provided by the embodiment of the present application, the calibration plate is arranged at the end of the robotic arm, and pose information of the end of the actuator is solved based on the mark points obtained by two contact operations, so that an influence caused by a repeated positioning error of the robotic arm may be eliminated; moreover, the structured light system is introduced to solve the three-dimensional point cloud coordinates of the marker points, which achieves higher accuracy in a Z-axis direction; then, the homogeneous transformation matrix of the calibration result is determined by specific matrix and vector, and other calculation methods, which is independent of a complex operation process, and can also ensure an accurate calculation result; and there is only an actual operation action of taking mark points for different poses of the calibration plate, which can meet the calibration requirement of multiple poses, without involving a high cost. Therefore, the embodiment of the present application can solve the technical problem that the requirement of actual calibration scene is difficult to meet due to the problems of low accuracy, complex measurement process, high cost and the like in the prior art.

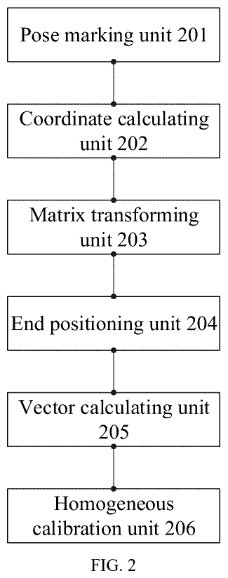

For easy understanding, with reference to FIG. 2, the present application provides an embodiment of an apparatus for calibrating an external actuator of a robot, which includes:
a pose marking unit 201 configured for enabling an end of a robotic arm with a calibration plate to be in contact with the actuator in different poses, and obtaining two different circular mark points and corresponding preset transformation matrices from a base to the end of the robotic arm;
a coordinate calculating unit 202 configured for respectively calculating three-dimensional point cloud coordinates of the two circular mark points based on a mapping relationship between pixel coordinates and point cloud coordinates in a structured light system;
a matrix transforming unit 203 configured for calculating a transformation matrix between two poses of the end of the robotic arm according to the preset transformation matrices to obtain a pose transformation matrix;
an end positioning unit 204 configured for calculating a position of an end of the actuator in a base coordinate system of the robotic arm according to the three-dimensional point cloud coordinates, the pose transformation matrix and a preset hand-eye matrix to obtain actuator coordinates;
a vector calculating unit 205 configured for calculating a direction vector of the end of the actuator in the base coordinate system of the robotic arm through two different sets of actuator coordinates; and
a homogeneous calibration unit 206 configured for calculating a homogeneous transformation matrix for calibrating and aligning the end of the actuator according to the direction vector to obtain a calibration result.

Further, the coordinate calculating unit 202 is specifically configured for:
moving the two circular mark points of the calibration plate to a visual field of the structured light system, and shooting a mark point image;
performing a center mark fitting operation according to the mark point image to obtain center pixel coordinates; and
calculating point cloud coordinates corresponding to the center pixel coordinates based on the mapping relationship between the pixel coordinates and the point cloud coordinates to obtain the three-dimensional point cloud coordinates of the circular marker points.

Further, the homogeneous calibration unit 206 is specifically configured for:
calculating a vector cross product according to a normalized direction vector and a normal vector of an arbitrary point in the base coordinate system of the robotic arm to obtain a rotation axis vector;
constructing a rotation matrix according to the rotation axis vector and an included angle between vectors, wherein the included angle between vectors is an included angle between the direction vector and the normal vector of the arbitrary point; and
calculating the homogeneous transformation matrix for calibrating and aligning the end of the actuator according to the rotation matrix and a preset translation vector to obtain the calibration result.

The present application further provides a device for calibrating an external actuator of a robot, wherein the device includes a processor and a storage;
the storage is used for storing a program code and transmitting the program code to the processor; and
the processor is used for executing the method for calibrating the external actuator of the robot in the method embodiment above according to an instruction in the program code.

In the several embodiments provided in the present application, it should be understood that the disclosed device and method may be implemented in other ways. For example, the foregoing device embodiments are only illustrative. For example, the division of the units is only one logical function division. In practice, there may be other division methods. For example, multiple units or assemblies may be combined or integrated into another system, or some features may be ignored or not executed. In addition, the illustrated or discussed mutual coupling or direct coupling or communication connection may be indirect coupling or communication connection through some interfaces, devices or units, and may be in electrical, mechanical or other forms.

The units illustrated as separated parts may be or not be physically separated, and the parts displayed as units may be or not be physical units, which means that the parts may be located in one place or distributed on multiple network units. Some or all of the units may be selected according to actual needs to achieve the objectives of the solutions of the embodiments.

In addition, each functional unit in each embodiment of the present application may be integrated in one processing unit, or each unit may exist alone physically, or two or more units may be integrated in one unit. The integrated units above may be implemented in a form of hardware, or may be implemented in a form of software functional unit.

The integrated units, if being implemented in the form of software functional unit and taken as an independent product to sell or use, may also be stored in one computer-readable storage medium. Based on such understanding, the essence of the technical solution of the present application, or a part contributing to the prior art, or all or a part of the technical solution may be embodied in a form of software product. The computer software product is stored in one storage medium including a number of instructions such that a computer device (which may be a personal computer, a server, or a network device, etc.) executes all or a part of steps of the method in the embodiments of the present application. Moreover, the foregoing storage medium includes: various media capable of storing the program code, such as a USB disk, a mobile hard disk, a Read-Only Memory (ROM), a Random Access Memory (RAM), a magnetic disk or an optical disk.

As described above, the embodiments above are only used to illustrate the technical solutions of the present application, and are not intended to limit the present application. Although the present application has been described in detail with reference to the above-mentioned embodiments, those of ordinary skills in the art shall understand that: the technical solutions recorded in the above-mentioned embodiments can still be modified, or equivalent substitutions can be made to a part of the technical features in the embodiments. However, these modifications or substitutions shall not depart from the spirit and scope of the technical solutions of the embodiments of the present application.

We claim:

1. A method for calibrating an external actuator of a robot, comprising the following steps:
enabling an end of a robotic arm with a calibration plate to be in contact with the actuator in different poses, and obtaining two different circular mark points and corresponding preset transformation matrices from a base to the end of the robotic arm;
respectively calculating three-dimensional point cloud coordinates of the two circular mark points based on a mapping relationship between pixel coordinates and point cloud coordinates in a structured light system;
calculating a transformation matrix between two poses of the end of the robotic arm according to the preset transformation matrices to obtain a pose transformation matrix;
calculating a position of an end of the actuator in a base coordinate system of the robotic arm according to the three-dimensional point cloud coordinates, the pose transformation matrix and a preset hand-eye matrix to obtain actuator coordinates;
calculating a direction vector of the end of the actuator in the base coordinate system of the robotic arm through two different sets of actuator coordinates; and
calculating a homogeneous transformation matrix for calibrating and aligning the end of the actuator according to the direction vector to obtain a calibration result.

2. The method for calibrating the external actuator of the robot according to claim 1, wherein, before the step of enabling the end of the robotic arm with the calibration plate to be in contact with the actuator in different poses, and obtaining the two different circular mark points and the corresponding preset transformation matrices from the base to the end of the robotic arm, the method further comprises the following steps:
fixing the calibration plate on the end of the robotic arm, adjusting a pose of the end of the robotic arm repeatedly, and simultaneously shooting a plurality of images and recording poses of the end of the robotic arm to obtain the pose of the end of the robotic arm;
determining the mapping relationship between the pixel coordinates and the point cloud coordinates according to intrinsic matrices of a camera and a projector of the structured light system; and
calibrating a matrix from a camera coordinate system to the base coordinate system of the robotic arm according to the pose of the end of the robotic arm and the intrinsic matrices to obtain the preset hand-eye matrix.

3. The method for calibrating the external actuator of the robot according to claim 1, wherein, the step of respectively calculating the three-dimensional point cloud coordinates of the two circular mark points based on the mapping relationship between the pixel coordinates and the point cloud coordinates in the structured light system, comprises:
moving the two circular mark points of the calibration plate to a visual field of the structured light system, and shooting a mark point image;
performing a center mark fitting operation according to the mark point image to obtain center pixel coordinates; and
calculating point cloud coordinates corresponding to the center pixel coordinates based on the mapping relationship between the pixel coordinates and the point cloud coordinates to obtain the three-dimensional point cloud coordinates of the circular marker points.

4. The method for calibrating the external actuator of the robot according to claim 1, wherein, the step of calculating the position of the end of the actuator in the base coordinate system of the robotic arm according to the three-dimensional point cloud coordinates, the pose transformation matrix and the preset hand-eye matrix to obtain the actuator coordinates, comprises:
calculating homogeneous coordinates of point cloud according to the three-dimensional point cloud coordinates; and
calculating the position of the end of the actuator in the base coordinate system of the robotic arm according to the homogeneous coordinates of point cloud, the pose transformation matrix and the preset hand-eye matrix to obtain the actuator coordinates.

5. The method for calibrating the external actuator of the robot according to claim 1, wherein, the step of calculating the homogeneous transformation matrix for calibrating and aligning the end of the actuator according to the direction vector to obtain the calibration result, comprises:
calculating a vector cross product according to a normalized direction vector and a normal vector of an arbitrary point in the base coordinate system of the robotic arm to obtain a rotation axis vector;
constructing a rotation matrix according to the rotation axis vector and an included angle between vectors, wherein the included angle between vectors is an included angle between the direction vector and the normal vector of the arbitrary point; and
calculating the homogeneous transformation matrix for calibrating and aligning the end of the actuator according to the rotation matrix and a preset translation vector to obtain the calibration result.

6. The method for calibrating the external actuator of the robot according to claim 5, wherein, before the step of calculating the homogeneous transformation matrix for calibrating and aligning the end of the actuator according to the rotation matrix and the preset translation vector to obtain the calibration result, the method further comprises the following steps:
taking the actuator coordinates calculated for the first time as homogeneous coordinates of pose of a current circular mark point when the end of the robotic arm is in a first pose state; and
constructing the preset translation vector according to the homogeneous coordinates of pose and coordinates of the arbitrary point.

7. An apparatus for calibrating an external actuator of a robot, comprising:
a pose marking unit configured for enabling an end of a robotic arm with a calibration plate to be in contact with the actuator in different poses, and obtaining different circular mark points and corresponding preset transformation matrices from a base to the end of the robotic arm;
a coordinate calculating unit configured for respectively calculating three-dimensional point cloud coordinates of the two circular mark points based on a mapping relationship between pixel coordinates and point cloud coordinates in a structured light system;
a matrix transforming unit configured for calculating a transformation matrix between two poses of the end of the robotic arm according to the preset transformation matrices to obtain a pose transformation matrix;
an end positioning unit configured for calculating a position of an end of the actuator in a base coordinate system of the robotic arm according to the three-dimensional point cloud coordinates, the pose transformation matrix and a preset hand-eye matrix to obtain actuator coordinates;
a vector calculating unit configured for calculating a direction vector of the end of the actuator in the base coordinate system of the robotic arm through two different sets of actuator coordinates; and
a homogeneous calibration unit configured for calculating a homogeneous transformation matrix for calibrating and aligning the end of the actuator according to the direction vector to obtain a calibration result.

8. The apparatus for calibrating the external actuator of the robot according to claim 7, wherein the coordinate calculating unit is specifically configured for:
moving the two circular mark points of the calibration plate to a visual field of the structured light system, and shooting a mark point image;
performing a center mark fitting operation according to the mark point image to obtain center pixel coordinates; and
calculating point cloud coordinates corresponding to the center pixel coordinates based on the mapping relationship between the pixel coordinates and the point cloud coordinates to obtain the three-dimensional point cloud coordinates of the circular marker points.

9. The apparatus for calibrating the external actuator of the robot according to claim 7, wherein the homogeneous calibration unit is specifically configured for:
calculating a vector cross product according to a normalized direction vector and a normal vector of an arbitrary point in the base coordinate system of the robotic arm to obtain a rotation axis vector;
constructing a rotation matrix according to the rotation axis vector and an included angle between vectors, wherein the included angle between vectors is an included angle between the direction vector and the normal vector of the arbitrary point; and
calculating the homogeneous transformation matrix for calibrating and aligning the end of the actuator according to the rotation matrix and a preset translation vector to obtain the calibration result.

10. A device for calibrating an external actuator of a robot, wherein the device comprises a processor and a storage;
the storage is used for storing a program code and transmitting the program code to the processor; and
the processor is used for executing the method for calibrating the external actuator of the robot according to claim 1 according to an instruction in the program code.
